(19) United States
(12) Patent Application Publication
(10) Pub. No.: US 2003/0200226 A1
(43) Pub. Date: Oct. 23, 2003

(54) System and method for interacting with legacy healthcare database systems

(75) Inventors: Brian P. Wells, Downington, PA (US); Anthony J. Penn, Havertown, PA (US)

Correspondence Address: PEPPER HAMILTON LLP, One Mellon Bank Center, 500 grant Street 50th Floor, Pittsburgh, PA, 15219, US

(73) Assignee: InteHealth Incorporated

(21) Appl. No.: 09/799,585

(22) Filed: Mar. 7, 2001

Related U.S. Application Data
(60) Provisional application No. 60/188,239, filed on Mar. 10, 2000.

(51) Int. Cl. G06F 17/60; G06F 7/00; G06F 17/00

(52) U.S. Cl. 707/104.1; 705/2

(57) ABSTRACT

A system and method for allowing legacy healthcare databases to interact with wired and wireless web-enabled access devices.

### PRIORITY

The following application claims priority from U.S. Provisional Patent Application Serial No. 60/188,239 filed Mar. 10, 2000, the disclosure of which is incorporated herein by reference.

[image]

[image]

[image]

on one disc with one copy accompanies this application, the disclosure of which is incorporated herein by reference. This appendix contains material which is subject to copyright protection. The copyright owner has no objection to the reproduction by anyone of the patent document or the patent disclosure as it appears in the Patent and Trademark Office patent file or records, but otherwise reserves all copyright rights. The following notice applies to the software and data as described below and in the drawings hereto: Copyright 2001 InteHealth Incorporated, All rights reserved.

### FIELD OF THE INVENTION

The present invention relates to interaction with legacy database systems. More particularly, the present invention relates to the use of wired and wireless web-enabled devices for interacting with legacy database systems and particularly healthcare database systems.

### BACKGROUND OF THE INVENTION

The provision and administration of healthcare has been greatly improved by the use of database technology. Hospitals and healthcare organizations maintain enormous databases of information relating to patient care, billing, inventory, insurance and other data utilized in providing healthcare services. During the past two decades, numerous applications have been developed that interact with these databases to improve quality, efficiency, and ease in providing healthcare. By way of example, applications exist for managing patient care, maintaining physician schedules, and tracking patient charges.

In the development of these databases, hardware limitations such as memory restrictions resulted in the development of software design techniques to optimize use of available memory. This resulted in databases designed using non-sequel based access methodologies, e.g., ISAM, VSAM, IMS, and hierarchical structure databases, resulting in closed databases that only the developer of the database could build tools to access. While it was advantageous to design databases utilizing these techniques, it has now been found that these databases are incompatible with current applications developed to operate with databases designed using current software design techniques. An example of this is the application software for wireless web-enabled devices such as Palm Pilots, 3G cellular phones or WAP enabled mobile phones.

The popularity and success of such devices is a testament to their usefulness. While these devices have been embraced by healthcare professionals for managing individual schedules and data, the full potential of these devices cannot be realized unless and until these devices can interact with the database of the organization to which they are associated. While it therefore would be advantageous to update the design of the “legacy” databases to permit interaction with current technology devices, the sheer volume of data stored in these databases and the ubiquitous nature of the databases in the operation of these organizations has made this impossible.

A need exists, therefore, for a mechanism for allowing legacy healthcare databases to interact with wired and wireless web-enabled access devices.

### SUMMARY OF THE INVENTION

The foregoing needs have been satisfied to a great extent by the present invention wherein, in one aspect of the invention, a method of accessing a legacy healthcare database system with a wireless web-enabled device is provided. In this method a request for data from a legacy database is input into a wireless web-enabled device. The request for data is transmitted to a connectivity server via a communications network where it is recast and forwarded to the legacy healthcare database system.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, is for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram representation of a system in accordance with a preferred embodiment of the present invention.

FIG. 2 is a block diagram representation of a software application used in the system of FIG. 1.

### DETAILED DESCRIPTION OF PREFERRED EMBODIMENTS OF THE INVENTION

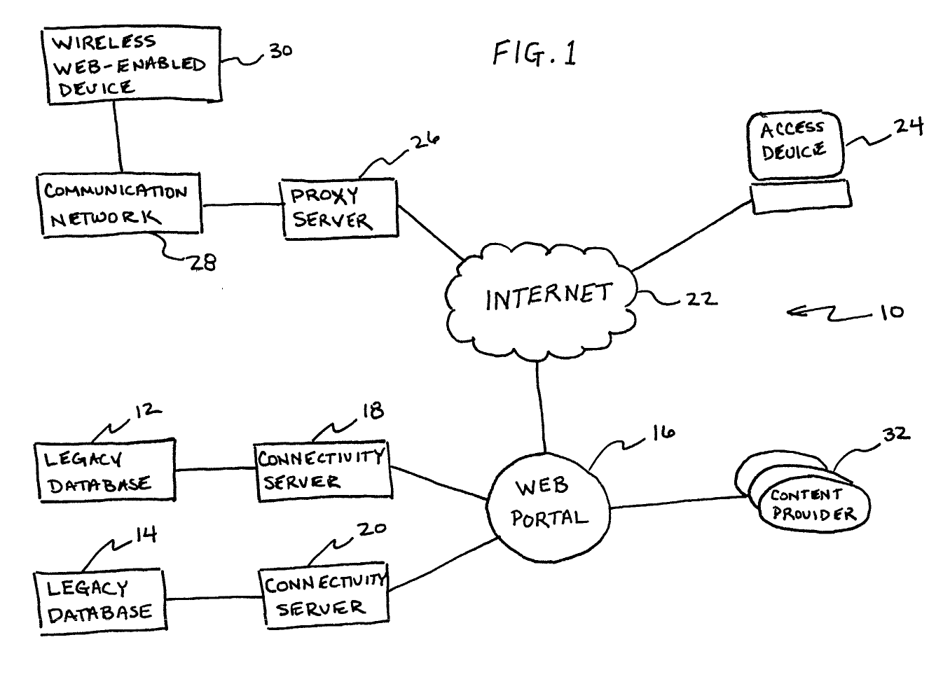

Referring now to the figures, wherein like reference numerals indicate like elements, in FIG. 1 there is shown a system 10 for permitting wireless access to legacy health care databases 12 and 14. The legacy databases are each linked to a web portal 16 through separate connectivity servers 18 and 20, respectively. The connectivity servers 18, 20 are “trained” to utilize the existing functionality of the legacy database system to extract data from the database and input data to the database.

The connectivity servers are connected to the web portal 16 via a secure socket layer (SSL) protocol. Each of the legacy databases 12, 14 is connected to its respective connectivity server 18, 20 via a Virtual Private Networks (VPN). Both the SSL and VPN are used to establish secure connections for the transfer of data. Because patient medical information will be transferred over these links, the system must comply with HIPAA regulations regarding the security of the data. While the presently preferred embodiment is described as using one or more SSL protocols and VPNs, it is to be understood that any technique for providing data security can be used in the system. As described herein, secure connections, encryption, device identifiers, and certificates are utilized to comply with HIPAA regulations.

The web portal 16 provides a link so that users can connect to the legacy databases 12, 14 over the Internet 22. Links over the Internet 22 can be established through a wired connection such as a personal computer (PC) 24 provided with a standard modem, DSL modem, ISDN line connection or the like, and running a desktop browser. It is to be understood that any wired connection device(s) could be substituted for the PC 24 in the preferred embodiment of FIG. 1, including a television running a set top browser (web TV) or a plurality of PCs connected via a LAN. To ensure privacy, the PC 24 and web portal 16 establish the link using an SSL protocol.

The web portal 16 may also be connected over the Internet 22 to a proxy server 26 associated with a wireless access device. In a preferred embodiment of the invention, the proxy server 26 is the Palm Computing Proxy Server which is linked, via a wireless communication network 28, such as the BellSouth Mobitex Pager Network, to a wireless web-enabled access device 30 such as the Palm Pilot VII. It is to be understood that the use of the Palm Computing Proxy Server and BellSouth Mobitex Pager Network is exemplary and that other devices that provide wireless Internet access can also be used to achieve the desired results of the present invention. Other wireless web-enabled devices that may be used in the system of the present invention include third generation (3G) cellular and WAP enabled mobile telephones, and Blackberry pagers.

To enable health care providers to access a legacy database 12, 14 through the wireless web-enabled device 30, an access application can be provided on the wireless device 30. This access application allows the health care provider to access information critical to the management of the health care provider's patients and professional and personal life. Using the access application, the health care provider is required to login at least once a day to ensure that the current user of the device is authorized.

A health care provider is able to identify and locate their patients in the legacy databases of the facilities that they visit. Once the patient is identified, the user can review order status, results, medications, patient demographics, patient history, etc. Orders may be placed for all hospital services including medications. Links are also provided through this access application to allow the user to quickly send e-mails to their office and check their professional e-mail boxes.

To maintain security of transferred data, security must be provided in the web portal 16 to proxy server 26 link and the proxy server 26 to wireless web-enabled device 30 link. User authentication protocols must also be used to ensure that only authorized users have access to the data through the wireless device.

The web portal 16 can also be used to provide links to content providers 32 to allow users access to other services outside the legacy database system 12, 14 through use of the system 10. The access application provided in the wireless device 30 can be provided with a “personal” link which is customized by the user to connect to individually selected content and service providers.

Depending on the access device used, users will be able to access a broad range of data and services using the system of the present invention. For example, wireless handheld devices such as the Palm Pilot support low graphic intensity and generally have small and expensive bandwidth to the servers they access. Personal web services that could be made available to users of these devices include e-mail, customized information such as news, travel, banking, investing, etc., and account aggregation services, such as are provided by Yodlee2go. Professional web services that can be made available to users of wireless handheld devices include some account administration functions, access to healthcare institution databases, supply ordering, medical research, and conference schedules.

For users employing common browsers to access the portal 16, the greater range of graphic intensity, higher bandwidth to the servers they access, and lower access cost would permit a greater range of services to be provided such as a greater range of account administration functions. Because cellular and mobile phones have the highest access costs, and typically the lowest graphic intensity, the services offered on these devices would typically be the most limited. For example, it is envisioned that the ability to do online research through these devices would not be provided until the cost of access reduces.

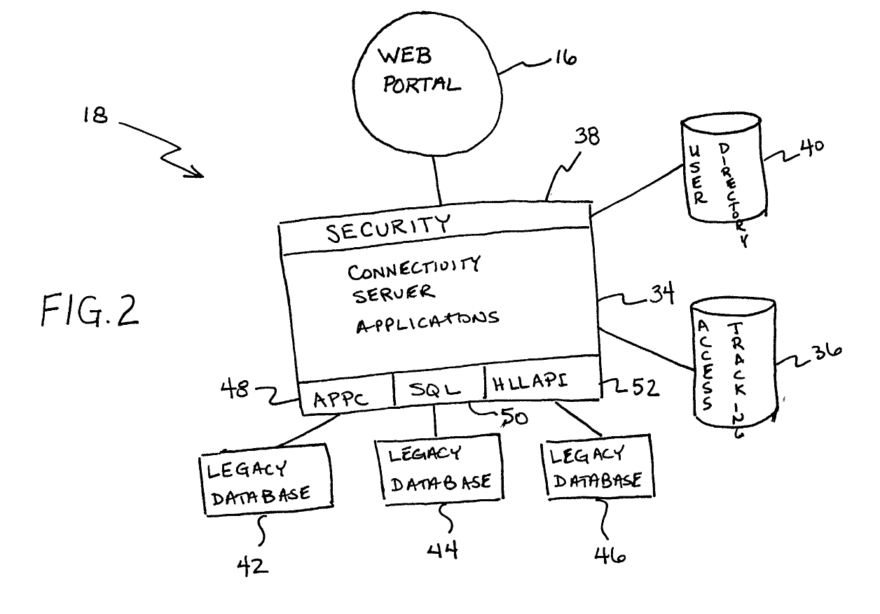

The structure of a connectivity server 18 is shown in more detail in FIG. 2 and includes the connectivity server applications 34 for linking to the web portal 16 and providing data in a format to be output on the different access devices 24, 30 (FIG. 1). The connectivity server applications 34 are linked to an access tracking database 36 used to create an audit trail for tracking the data accessed by a user. Also provided in the connectivity server 18 is a security application 38 for providing the secure links, encryption of data, and authentication of users to the web portal 16. The security application 38 links to a user directory database 40 used in authenticating users permitted to access the legacy databases 42, 44, 46.

In order to provide a platform for object oriented connectivity to legacy database systems the connectivity server 18 can be provided with a number of communication programs. An example of such a communication program is the Advanced Program to Program Communications (APPC) program 48. The APPC program 48 allows the connectivity server 18 to send data to, and receive data from, a legacy database 42 provided in a client server network. A Structured Query Language (SQL) program 50 can also be provided to allow users to access data stored in a legacy database 44 which is constructed as a relational database. A High Level Language Application Program Interface (HLLAPI) program 52 can also be provided to allow a user's wireless device 30 to emulate a terminal in a mainframe system. Data in the legacy database 46 can be accessed by a user using the HLLAPI program 52 by emulating a terminal in the mainframe system to access the data and then “screen scrape” the data. In addition to the foregoing, other programs either currently known or which may be developed for accessing legacy databases may also be provided in the connectivity server 18.

In data input mode, the connectivity servers 18, 20 (FIG. 1) receive information from any device and input the data into the legacy system as the system expects to see it. In data extract mode these connectivity servers gather information using the legacy system's existing functionality and format it differently depending on the receiving device's individual characteristics. The device's unique characteristics do not affect the way the connectivity objects interact with the legacy system. It should be understood that while there are only two legacy databases shown in the exemplary embodiment of FIG. 1, and three shown in the exemplary embodiment of FIG. 2, the system can provide connection to any number of legacy databases.

The technology components, i.e., functionalities, provided in the system of the present invention are broadly categorized as Clinical, Administrative, Utility, Web, and Security. Technology components that fall within each of these categories are described below. In the description that follows it should be understood that the “user” of the technology components of the system are healthcare providers such as physicians.

Clinical

Applications provided under the Clinical category include a Patient Search, Results, Medications, Pharmacy, Independent Facility Results, and Order Entry applications. The Patient Search application enables the user to perform a real-time search in the legacy hospital system for a patient five different ways. The two most commonly used methods are physician census and group census. Physician census displays all patients assigned to the physician. Group census displays all patients assigned to a group of physicians. The other three methods allow the user to search by patient last name (full or partial), patient number, or nurse station. Once the list of patients is returned, the user has the ability to select a patient from the list and perform subsequent requests on that patient (results, medications, charge capture).

The Results application allows a user to view patient results real-time. Depending upon the options provided by the legacy system, the user can select results based upon time parameters (last two days, last five days, all, etc.) and result type (lab, x-ray, nursing comments, etc.) The Medications application gives the user the ability to view the currently active medication orders for a patient. Information displayed includes drug name, start and stop dates, frequency, route, dose, etc.

The Pharmacy Support application encompasses several distinct but integrated functions including drug selection with formulary validation and co-pay reporting, prescription writing, prescription to PBM routing. To utilize this function on the palm device the physician would need to know and select the patient's pharmacy benefit plan information. In addition to developing a separate application, this functionality could be provided by establishing a partnership with a vendor that currently has an Internet enabled gateway to the leading PBMs for the desired functionality.

The Independent Facility Results application permits users to access independent facility results in addition to hospital based results. The user will select the patient and then a list of available results. This functionality may be provided through a partnership with a vendor that has an Internet enabled gateway to the leading independent result providers for the desired functionality. The Order Entry application enables users to place orders for diagnostic tests, medications and other hospital based services.

Administrative

Applications provided under the Administrative category include the Scheduling, Charge Capture, and Disease Management Steerage applications. Using the Scheduling application a user's office schedule can be viewed for a selected date. The information returned displays start time, duration, appointment type, appointment location, and description for all appointments for the selected date. Selecting a patient using the Scheduling application brings up a charge capture screen.

The Charge Capture application allows users to capture charges incurred for hospital based and office based patients. After selecting the patient to charge from either the results screen of the Patient Search or the results screen of the Scheduling application, the user enters the required charge information (diagnosis code(s), procedure code(s), date of service, referring doctor number, etc.) The captured charge information along with information stored in the physician's billing profile on the connectivity server 18 is stored on a web server. Office charge data entry staff utilize the web server to enter charges into the practice management system or review the processing of a CareServ based process that electronically entered the charges into the practice management system. When reviewing the results of the electronic charge interface processing, office staff will be resolving coding errors, filling in incomplete information and ensuring that all submitted charges are successfully processed.

The Disease Management Steerage application alerts the user that a patient is or may be eligible for enrollment in a disease management program. Eligibility would be determined by matching criteria for the disease management program against patient treatment and or symptoms data stored in the legacy database.

Utility

Six applications included in the Utility category include Login, Credit Card Capture and Service Activation, Server Monitor, Setup, Fax, and Text Messaging. The Login application ensures that all wireless access is secure by requiring the device users to login to the connectivity server at regular intervals (every four hours for example). The login utility captures a user id and password and performs authentication.

The Credit Card Capture and Service Activation application is a wireless application that captures the new user's credit card information, validates it, and begins a monthly charging process. Until this information is captured and validated, the user's device cannot access the connectivity server(s). The Server Monitoring application permits remote server monitoring to enable support staff of the web portal provider to identify server status as well as track utilization from anywhere at anytime.

The Setup application allows the wireless user to wirelessly download software updates to the wireless web-enabled device system application. The Fax application allows users to send short fax messages to any fax machine in the world from the wireless web-enabled device 30. Similarly, the Text Messaging application allows users to send short text messages to any mobile device in the world that can receive text messages (pagers, cell phones, etc.) from the wireless web-enabled device.

Web

An application provided under the Web category is the Charge Lookup application This application enables rapid implementation of charge capture by providing a template that permits a physician's office staff to view and print detailed information on each charge captured by the physician. The information is secured by a user id and password that restricts office users to viewing only those charges for the physician(s) they support. This information can then be data entered or electronically interfaced into the billing function of a practice management system.

Security

The Security category contains all applications used to ensure that all proposed HIPAA security and electronic signature as well as health information privacy regulations will be enforceable. In a preferred embodiment the Palm VII is used as the platform for the wireless web-enabled device 30. The security features provided by the Security application include:

Device locking requiring a password to unlock

User specific, timed authentication utilizing user ids and passwords assigned by the web portal provider

DESX encryption

Message integrity checking

Denial-of-service blocking

SSL access over the Internet

Physical security of the system servers

The processing flow through the wireless web-enabled device software component (CarePad in the description that follows) and connectivity servers software components (CareServ in the description that follows) of a particularly preferred embodiment of the invention will now be described. Brackets surround the actual software source file names. Source file names that end with “.htm” are stored on the wireless web-enabled device 30, e.g., the Palm VII, as part of a Palm Query Application (PQA). Source file names that end with “.asp” are Application Server Pages (ASP) stored on the connectivity servers 18, 20 running Microsoft NT, with Internet Information Server (IIS). Source file names that end with “.vbp” are Visual Basic projects consisting of multiple modules and class modules that are compiled into an ActiveX DLL for reference from an ASP. These modules contain the software needed to communicate directly with a legacy (i.e. text based) Hospital Information System (HIS, Practice Management System (PMS) and/or others (payors, government, etc.). This communication is accomplished using API calls from Visual Basic to software provided by various terminal emulation software vendors.

In the description that follows reference is made to source code in the computer program listing appendix. An SQL compliant database is also referenced in the description that follows.

The typical flow of information follows the following outline:

1. The user selects the CarePad application [CarePad.htm] that is running on a Palm VII. This application is currently a PQA as defined in Palm Computing's Web Clipping Guide design standards. Eventually other wireless devices will also be supported (WAP enabled phones, Blackberry pagers, etc.).

2. The user initiates a login process on the Palm VII that requires a user id and password [login.htm]. These data items cannot be saved on the device and must be entered at each login. The login process can be placed in front of every access attempt or can be required at hospital defined time periods (24 hours, 1 hour, etc.). A balance between security and user productivity must be reached.

3. The login request is transmitted over the Cingular Wireless Mobitex network to a proxy server at Palm Computing and then on to the web portal (InteHealth.net in the presently described preferred embodiment). This and all transmissions include these security provisions:

Duplicate device transmitter connections are detected and disabled.

Time division multiplexing ensures that 512 byte packets of wireless data are sent on different channels making it difficult for “spys” to determine where a specific message begins and ends.

Each message is encrypted using strong Data Encryption Standard eXtended (DESX) encryption combined with superior elliptic curve cryptography (ECC) key management. The ECC keys are 163 bit, device created (i.e. no human ever sees them), and are erased from the device's memory after every transaction.

Each message also passes through a message integrity check (MIC) function to ensure that no hacker has substituted a forged message for actual data.

Communication between the Palm Computing proxy server and InteHealth.net is accomplished using Secure Socket Layer (SSL) protocols for data encryption and server authentication. This eliminates the threat of a session hijack or of communications with a spoofing “server”. All Palm Computing and InteHealth.net Internet servers reside behind firewalls in physically secure locations with audit trails for physical access, configuration and server activity.

4. The login request sent from the Palm device launches a logon application on the CareServ web server [login.asp, login.bas]. This application receives the user id, password and device id. Using these three data items, the CareServ security database is queried to ensure that a valid record exists for this combination. If it does exist, the record is date and time stamped to indicate the last successful login. All future requests to the CareServ server will check the date and time stamp and a hospital defined user authentication expiration duration. If the authentication has expired,a request for login will be transmitted back to the Palm before the current request is served.

5. The user is presented with a menu [CarePad.htm] of sub-applications to launch:

The user's schedule or another user's schedule

Patients in a selected hospital that are linked to a selected provider with access to their associated demographic, history and clinical information (orders, results, medications). The user can view existing data and/or create new data (e.g. orders, charges, etc.)

Office communication via email

Personal information (stock portfolio performance, bank balances, travel arrangements, email, etc.)

Medical Research

Help system for CarePad.

The following sections correspond to each menu selection.

Schedule sub-application

1. The user is presented with a screen (my schedule.htm) that allows the selection of a date for schedule viewing. By pressing the “Submit” button the user's schedule is automatically retrieved [schedule.asp, clsOneSchedule.cls].

2. When CareServ receives the request, it looks up the user's PMS specific code that will retrieve the user's schedule from the system. Access to the PMS will be over a virtual private network between InteHealth.net and the hospital data center or ASP. The PMS terminal session is created using logon id(s) supplied by the hospital for InteHealth's use. These PMS logon ids can have whatever security restrictions the hospital requires provided that InteHealth can access the data needed to meet the remote user's needs. CareServ then navigates the PMS to extract the needed information, formats it into an HTML response and returns it to the Palm device.

3. The user also has the option of selecting the “My Other Resource Schedules” link. This will display a page specific to the user listing other individuals whose schedules the user has permission to view [my_resources.asp, clsResourceList.cls].

4. When this page is displayed, the user has the option of selecting a date and a specific resource. By pressing the submit button the selected schedule is retrieved [schedule.asp, clsOneschedule.cls].

5. Other options in this application include the Help screen [helpschedule.htm] and the ability to link to other sub-applications.

Patients Sub-Application

1. The user is presented with a screen [my_census.htm] that allows the selection of different hospitals and patient search methods. By pressing the “Submit” button the user's patients are automatically retrieved.

2. The list of “other providers” that the user can select from is also controlled by the hospital in conjunction with the physician. This list is maintained in the CareServ security database. [my_providers.asp, providerlist.basp]

3. Once the user selects the desired provider, the CarePad application transmits the request to InteHealth.net.

4. When InteHealth.net receives the request, it validates the device id and establishes a terminal session [census.asp, clsCensus.cls].

5. Once the HIS session is established, normal HIS screens and screen flow will be utilized to access the requested data for locating the patients assigned to the wireless device user. Once the list of patients along with minimal identifying and location information (nurse station, bed, status, name, number) is retrieved from the HIS, an HTML text string is created and returned to the Palm VII where it is processed and displayed to the user.

6. The user can then select a patient by clicking on the underlined number adjacent to each patient listed. This will then send the patient number and device id back to InteHealth.net for processing by the CareServ web server [patient.asp, clspatient.cls].

7. CareServ will then follow the HIS screen flow to extract summary information about the patient and build an html page that provides patient information and links to the patient's orders, results, billing and other pertinent clinical information.

8. Selecting the orders link will send the patients number and device id back to InteHealth.net for processing by the CareServ web server.

9. Selecting the results link will send the patient number and device id back to InteHealth.net for processing by the CareServ web server.

10. Selecting the meds link will send the patient number and device id back to InteHealth.net for processing by the CareServ web server.

11. Selecting the billing link will send the patient number and device id back to InteHealth.net for processing by the CareServ web server [billing.asp]. The billing function allows the user to specify a date of service and select the appropriate service code. This information is then sent back to InteHealth.net for storage and later access over the web for manual data entry into the user's billing system or for automated interface into the user's billing system. This same billing function is also available from the Schedule sub-application and performs the same way once a patient is selected. Charges included in the patients bill may be generated using the charge capture application (ADO.bas, modGeneral.bas CareServe.asp).

12. The billing function (billing.htm, billnew.htm, billtwo.htm) allows the user to specify a date of service place of service, and select appropriate diagnosis, procedure, modifier and referring doctor codes. The selection of these codes is made possible through the device resident utility named CareCodes (MemoPad.c, MemoPadRsc.c, MemoPad.Rsc.h) that contains each individual user's list of preferred codes. The user can use this utility to add or modify the codes and their descriptions on the device with no required involvement from the office staff. When performing a device hot sync to the user's PC, the database of codes on the device is synchronized with the web server (VBMain.bas, CToDoRecords.cls, test.cls, firmProgress.frm). Conversely the office staff can review and maintain the user's list of codes on the web server and upon the next hot sync the user's device will reflect the office staff's changes. The user also has the ability to review previously captured charges, regardless of user, for the selected patient (clsChargelnq.cls, ci.asp).

Office Communication Sub-Application

1. This application enables the user to quickly communicate with their office via email. The link from the main CarePad menu links to the CareServ web server [my_office.asp]. This module looks up the user's device id and returns an html page with a pre-built link that will create an email to the user's office.

2. Another link also exists that will allow the user to check their email remotely. This link launches the iMessenger application that comes standard with the Palm VII. Alternatively it could link to another Palm VII application that can remotely access the user's POP3 or IMAP email box on an Internet server.

Personal Information Sub-Application

1. This application enables the user to quickly access personal information (bank balances, stock portfolios, news, travel,etc.) wirelessly [my life.asp]. This module looks up the user's device id and returns an html page with pre-built links specific to the user. An example is the currently available service at www.yodlee.com. This service also provides a Palm VII PQA that enables the user to look at personal information. Another example would be a link to a personal email box.

Medical Research

1. This application enables the user to quickly access research information (NIH, Medline, PDR, Merck Manual, etc.) wirelessly [my_research.asp]. This module looks up the user's device id and returns an html page with pre-built links specific to the user.

2. Selecting the NIH link will send the device id back to Intehealth .net for processing by the CareServ web server.

3. Selecting the Medline link will link to a third party application for Medline access from BioMedNet.

4. The CareServ application will initiate a TELNET terminal session over the Internet to the National Institute of Health and provide an html page with multiple links for search options.

5. The user can then enter the search string, select the desired search option and click “Submit.”

6. A message will be sent back to Intehealth.net for processing by CareServ using the NIH screens. An html page of retrieved results will be formatted and returned to the user's Palm VII.

Help Sub-Application

1. This selection links to a list of help pages [helpCarePad.htm,

| | | |
|---|---|---|
| helpcensus.htm, | helpschedule.htm, | helpoffice.htm, |
| helplife.htm, | helpresearch.htm, | helpsetup.htm, |
| about_carepad.htm, | helpemail.htm, | helpmessage,htm, |
| helporders.htm, | helpresults.htm, | helpvisit.htm, |
| helpbilling.htm]. | | |

The above description and drawings are only illustrative of preferred embodiments which achieve the objects, features, and advantages of the present invention, and it is not intended that the present invention be limited thereto. Any modification of the present invention which comes within the spirit and scope of the following claims is considered to be part of the present invention.

What is claimed is:

1. Method of accessing a legacy healthcare database system with a wireless web-enabled device, comprising the steps of:
transmitting non-sequel accessed data from the database system to a server;
converting said non-sequel accessed data into data which can be displayed on a wireless device;
transmitting said converted data over a data network to a wireless communications network; and
transmitting said converted data over said wireless communication network.

2. The method of claim 1, wherein said converting step is accomplished by an application including a Advanced Program to Program Communications (APPC) program.

3. The method of claim 1, wherein said converting step is accomplished by an application including a High Level Language Application Program Interface (HLLAPI) program.

4. The method of claim 1, wherein said converting step is accomplished by an application including a Structure Query Language (SQL) program.

5. The method of claim 1, further comprising the step of limiting access to said database system through said server.

6. The method of claim 5, wherein said step of limiting access is accomplished using an encryption program.

7. The method of claim 5, further comprising the step of tracking access to said database system through said server.

8. The method of claim 5, further comprising the step of transmitting data to said server from a content provider.

9. The method of claim 1, further comprising the step of receiving said converted data at a wireless device.

10. The method of claim 9, wherein said wireless device is a text pager.

11. A system for accessing a legacy healthcare database system, comprising:
a non-sequel accessed healthcare database system;
a portal connected to said database system and to a data network;
a communication network connected to said data network for wirelessly transmitting data received over said network;
wherein said database system is connected to said portal through a server; and
wherein said server is trained to utilize the existing functionality of the database system to extract data from said database system and input data to the database system.

12. The system of claim 11, wherein said network is the Internet.

13. The system of claim 11, wherein said server further comprises:
a security application for limiting access to said database system through said portal; and
a connectivity program that connects said portal to said database system.

14. The system of claim 13, wherein said server further comprises an APPC program for converting non-sequel accessed data received from said database system into a format that can be displayed on a wireless access device.

15. The system of claim 13, wherein said server further comprises a SQL program for converting non-sequel accessed data received from said database system into a format that can be displayed on a wireless access device.

16. The system of claim 13, wherein said server further comprises HLLAPI program for converting non-sequel accessed data received from said database system into a format that can be displayed on a wireless access device.

17. The system of claim 13, further comprising an application associated with said server for creating an audit trail of access to the database system.

18. The system of claim 13, further comprising a wireless access device for receiving data from said database system over said communication network.

19. The system of claim 18, wherein said wireless access device is a text pager.

20. The system of claim 18, further comprising a desktop computer connected to said network for accessing said database system.
